(19) United States
(12) Patent Application Publication
(10) Pub. No.: US 2025/0363655 A1
(43) Pub. Date: Nov. 27, 2025

(54) PACKAGE DIMENSIONING

(71) Applicant: Position Imaging, Inc., Portsmouth, NH (US)

(72) Inventors: Narasimhachary Nallana Chakravarty, Rollinsfod, NH (US); Estuardo Carpio, Arlington, MA (US)

(21) Appl. No.: 19/217,527

(22) Filed: May 23, 2025

Related U.S. Application Data
(60) Provisional application No. 63/651,837, filed on May 24, 2024.

(51) Int. Cl. G06T 7/60; G06K 7/14; G06T 7/12; G06T 7/20; G06T 7/579

(52) U.S. Cl. CPC G06T 7/60; G06K 7/1447; G06T 7/12; G06T 7/20; G06T 7/579; G06T 2207/20084

(57) ABSTRACT

A device, system, and method for dimensioning objects comprise capturing, by an optical sensor of each of one or more mobile devices, one or more images of an area containing an object; estimating the three-dimensional representation of the captured images using depth estimation techniques; identifying the object within the captured images; and calculating dimensions of the object based on the three-dimensional representation.

### RELATED APPLICATIONS

This application claims priority to U.S. provisional application No. 63/651,837, filed May 24, 2024 and entitled “Package Dimensioning,” the entirety of which is incorporated by reference herein.

This application is related to U.S. provisional application No. 63/468,818, filed May 25, 2023 and entitled “Package Dimensioning at a Self-Serve Packaging Kiosk,” the entirety of which is incorporated by reference herein.

### FIELD OF THE INVENTION

The invention relates to systems, methods, and devices for measuring an object's dimensions and/or other features such as weight using depth sensors.

### BACKGROUND

For many businesses, the need to ship packages is essential. Critical to profitability for such businesses, and to customer satisfaction, is the accurate calculation of shipping costs. The size and weight of the package are principal factors in determining shipping costs. Commonly, heavier packages cost more to ship because of the increased handling and fuel costs to the carriers. The dimensions of a package can also affect shipping cost because of the space the package will occupy when transported.

### SUMMARY

In one aspect, a method for dimensioning objects using a mobile device comprises capturing, by a mobile device camera, an image of an object using a camera integrated into the mobile device; estimating, by a neural network, monocular depth information from the captured image; then generating a point cloud representation of the object based on the monocular depth information; then segmenting the object within the image using another neural network; and calculating dimensions of the object based on the point cloud representation.

In some embodiments, segmenting the object using the other neural network is automatically executed when the object is the sole item in a field of view of the camera. In some embodiments, the method further comprises tracking the movement of the object from a dimensioning area to a staging area using a separate tracking system to create a chain of custody.

In another aspect, a method for estimating dimensions of objects using a mobile device comprises capturing, by a mobile device camera, multiple images of an object from different perspectives; estimating, by a visual simultaneous localization and mapping system, dimensions of the object based on the device's movement around the object; then generating spatial mapping data to calculate accurate dimensions of the object within the mobile device's environment.

In some embodiments, the object segmentation using the neural network is automatically executed when the object is the sole item in the field of view. In some embodiments, the method further comprises tracking the movement of the object from a dimensioning area to a staging area using a separate tracking system to create a chain of custody.

In another aspect, a method for verifying labels during object dimensioning using a mobile device comprises detecting an attachment of a label to the object during the dimensioning process; then scanning a barcode on the label using integrated scanning capabilities of the mobile device; then performing an Optical Character Recognition (OCR) operation on the label to confirm accuracy and relevance to the dimensioning process and providing real-time feedback regarding the successful verification of the label.

In yet another aspect, a method further comprises estimating depth information and generating a three-dimensional representation of the object using additional sensors integrated into the mobile device. Such sensors may include a stereo camera, a time-of-flight sensor, a structured light sensor, a LiDAR module, or any combination thereof. By incorporating these additional sensing modalities, the system may improve depth estimation accuracy, particularly in challenging environments such as low-light or textureless surfaces. The system may dynamically select among available sensors or fuse data from multiple sources to optimize the quality of the depth information and the resulting three-dimensional representation.

In certain embodiments, the method may further comprise generating a three-dimensional surface mesh or a CAD-compatible model of the object based on the three-dimensional representation. This mesh or model may be used for downstream applications such as computer-aided design, 3D printing, virtual reality, augmented reality, or digital archiving. Additionally, the system may compute not only linear dimensions but also volumetric properties, surface area, or inferred weight of the object, optionally utilizing material density data retrieved from a database.

In some embodiments, the method may include presenting the calculated dimensions and other object characteristics as augmented reality overlays on a display of the mobile device, superimposed on the live camera view of the object. The overlays may provide interactive controls allowing a user to manually adjust detected edges, reference points, or measurement markers to refine the dimensioning process in real time. The augmented reality interface may further display warnings or guidance to assist the user in capturing optimal views or identifying occlusions.

In another aspect, the method may include performing collaborative dimensioning using multiple mobile devices operating in proximity to the object. Each device may capture images or depth data from different perspectives and may transmit such data over a network to a central processing unit, an edge computing node, or a cloud server. The system may then fuse data from multiple devices to generate a more complete or higher-accuracy three-dimensional representation of the object.

In some embodiments, the method may further comprise detecting and dimensioning multiple objects within a single image or image sequence. The system may perform multi-object segmentation to isolate and calculate the dimensions of each individual object present in the scene. The resulting measurements, along with associated metadata, may be exported to an external system, such as an inventory management platform or a logistics database, thereby facilitating integration with automated workflows for shipping, warehousing, or asset tracking.

Additionally, the label verification process may include scanning not only barcodes but also QR codes, RFID tags, and NFC tags attached to the object. The system may perform a validation operation in which label information is cross-checked against a database of known object attributes, ensuring that the measured dimensions fall within acceptable tolerances specified for the labeled item. The system may generate a notification or alert in cases where a discrepancy between the measured dimensions and the label metadata is detected.

In certain implementations, the method may further include tracking changes in the object's dimensions over time by periodically capturing new images and recalculating the object's measurements. This time-based monitoring may be used to detect deformation, shrinkage, expansion, or wear of the object, enabling use cases in manufacturing quality control, construction monitoring, or medical applications such as tracking swelling or wound healing.

In various embodiments, the three-dimensional representation of the object may be implemented using any suitable data structure encoding geometric information in three-dimensional coordinates. Such representations may include, but are not limited to, point clouds, voxel grids, polygon meshes, parametric surface models, implicit neural representations, or other data structures capable of representing spatial geometry in three-dimensional space. The system may select or convert between these representations as appropriate for different processing steps, such as segmentation, measurement, visualization, or export.

In certain embodiments, the system may rely solely on one or more RGB cameras to estimate the dimensions of the object, without requiring dedicated depth sensors or stereo imaging. In such embodiments, a neural network may be configured to infer depth information directly from a single RGB image captured by the mobile device, using monocular depth estimation techniques. The neural network may be trained on a dataset of objects in various environments to learn depth cues from features such as shading, texture gradients, perspective, occlusions, and relative sizes of known objects in the scene. Alternatively, or additionally, the system may utilize information about the imaging environment, such as the distance between the camera and a reference plane, known dimensions of nearby reference objects, or other geometric constraints, as input parameters to a dimensioning algorithm. This approach enables estimation of the object's three-dimensional size using only RGB image data in combination with contextual or environmental information.

In another aspect, a method for dimensioning objects using a mobile device, comprises capturing, by a mobile device camera, one or more images of an area containing an object; estimating the three-dimensional representation of the captured images using depth estimation techniques; identifying the object within the captured images; and calculating dimensions of the object based on the three-dimensional representation.

In some embodiments, the method further comprises segmenting the object within at least one image of the one or more images, which is automatically executed when the object is a sole item in a field of view of the camera.

In some embodiments, the method further comprises tracking the movement of the object from a dimensioning area to a staging area using a separate tracking system to create a chain of custody.

In some embodiments, segmenting the object is executed per the user input on the touchscreen by tapping the object in the one or more images.

In some embodiments, the mobile device camera is part of a wearable device. In some embodiments, the mobile device camera is part of an augmented reality device.

In some embodiments, the augmented reality device projects the dimensions of the object around the object when viewed through the device.

In another aspect, a method for verifying labels during object dimensioning using a mobile device, comprises detecting an attachment of a label to the object during a dimensioning process; scanning the label using integrated scanning capabilities of the mobile device; and using the information obtained through the scanning to confirm accuracy and relevance to the dimensioning process.

In some embodiments, the mobile device scans the barcode on the label using one or more cameras. In some embodiments, the mobile device scans a barcode on the label using a laser based barcode scanner. In some embodiments, mobile device captures the image of the label placed on the object, and performs an Optical Character Recognition (OCR) operation to obtain the information. In some embodiments, the mobile device uses NFC to scan the label. In some embodiments, the mobile device scans an RFID tag on the object. In some embodiments, the method further comprises tracking the movement of the object from a dimensioning area to a staging area using a separate tracking system to create a chain of custody.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a functional diagram of an embodiment of a mobile device performing an operation, in accordance with some embodiments.

FIG. 2 is a functional diagram of an embodiment of a simultaneous localization and mapping (VSLAM) system performing an operation, in accordance with some embodiments.

FIG. 3 is a flow diagram of a method for depth estimation, in accordance with some embodiments.

FIG. 4 is a flow diagram of a method for depth estimation, in accordance with some embodiments.

FIG. 5 is a functional diagram of an embodiment where multiple objects are present within the field of view of a mobile device performing a package dimensioning operation.

### DETAILED DESCRIPTION

The present invention relates to a system and method for measuring an object's dimensions and, optionally, the weight of the object, using a mobile device such as an off-the-shelf smartphone.

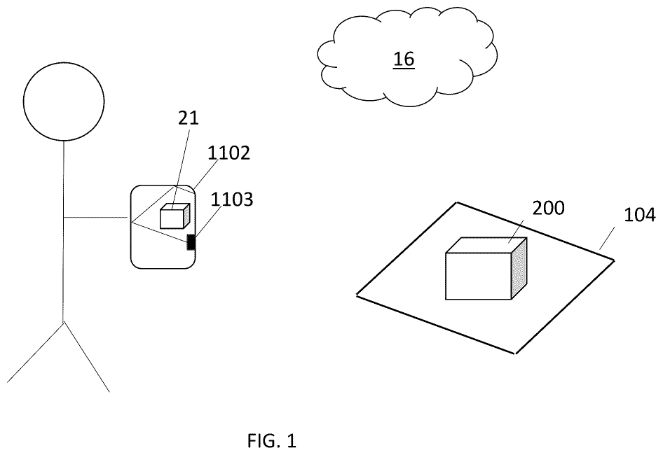

An embodiment of the present invention incorporates a novel approach to obtaining dimensions of a parcel or item utilizing a simplified setup, which includes a simple RGB camera. This camera can be either fixed in position, or as shown in FIG. 1, the camera 1103 integrated into a mobile device 1102, providing flexibility and accessibility for users. A key component of this embodiment is the integration of a neural network 16 designed to estimate monocular depth information from the RGB images captured by the camera 1103.

Upon capturing an image by a camera 1103 of a mobile device 1102, the neural network 16 processes the visual data to generate depth information for each pixel in the image 21. This monocular depth information is then utilized to construct a point cloud representation of the object of interest within the captured scene. The point cloud serves as a spatial reference that enables accurate determination of the object's dimensions.

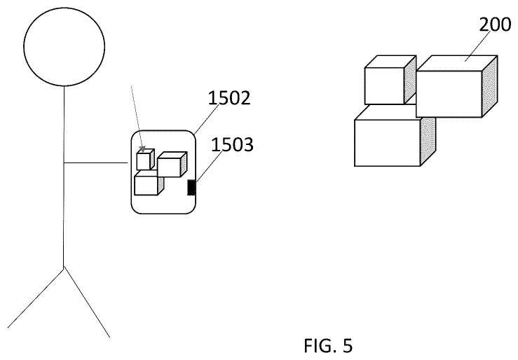

Furthermore, in scenarios where multiple objects are present within the field of view, for example, shown in FIG. 5, an additional neural network can be employed to segment and identify the object of interest. If the target object is the sole item in the field of view, the segmentation process can be automatically executed without requiring user input. However, as shown in FIG. 5, if multiple objects are detected, the user interface on a mobile device 1502 enables the user to select the desired object simply by tapping on it, illustrated by an arrow. This user-friendly interaction ensures efficient and accurate dimension measurement even in complex visual environments. FIG. 5 also illustrates a camera 1503 similar to or the same as the RGB camera 1103 of FIG. 1. Although not shown in the figures, other features described above, for example, sensors for generating a three-dimensional representation of the object, method comprise detecting and dimensioning multiple objects within a single image or image sequence, and so on, may be performed by the systems and methods described in FIGS. 1-5.

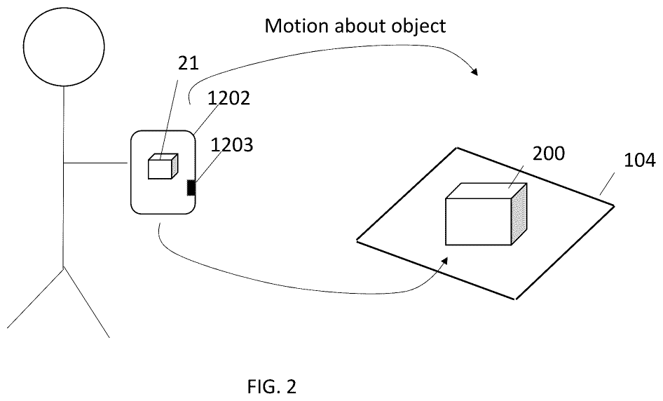

Another embodiment of the present invention leverages a mobile interface and visual SLAM (Simultaneous Localization and Mapping) technology, for example, shown in FIG. 2, to estimate the dimensions of a targeted object 200. In this approach, the mobile device utilizes its camera 1203 and optional onboard sensors to perform real-time spatial mapping and localization. Initially, the device 1202 identifies and establishes a ground plane within the environment, which serves as a reference for subsequent measurements. Through visual SLAM techniques, the device 1202 continuously updates its position and orientation relative to the surroundings, enabling accurate tracking of its movement.

Once the mobile device 1202 is localized, a neural network can be employed to segment the image 21 of the object of interest 200 within the captured scene, similar to previous embodiments. By isolating the target object, the device 1202 can then utilize its spatial awareness and camera feed to facilitate dimension estimation. Users can interact with the object by moving the mobile device around it, much like in augmented reality applications, to capture multiple perspectives and gather necessary data for dimension calculations. This approach provides a user-friendly and intuitive method for obtaining object dimensions 21 on a mobile platform, combining the capabilities of visual SLAM with neural network-based object segmentation to enable precise and efficient measurements directly from a handheld device.

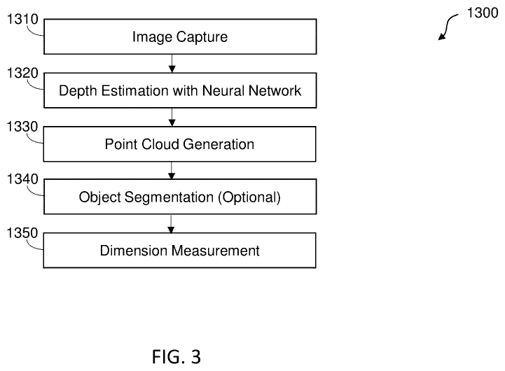

FIG. 3 is a flow diagram of a method 1300 for depth estimation, in accordance with some embodiments.

At step 1310, at least one image is captured by a camera, for example, described herein. For example, RGB image of the object or parcel is captured using a fixed or mobile camera.

At step 1320, the RGB image is input into a neural network designed for monocular depth estimation. The neural network processes the image to generate depth information for each pixel.

At step 1330, the monocular depth information is used to construct a point cloud representation of the object using the camera parameters.

At step 1340, another neural network is used to segment the object of interest within the image. If the object is the only one in the field of view, automatic segmentation can occur without user input.

At step 1350, the dimensions of the object are calculated based on the point cloud representation using either segmentation or change analysis.

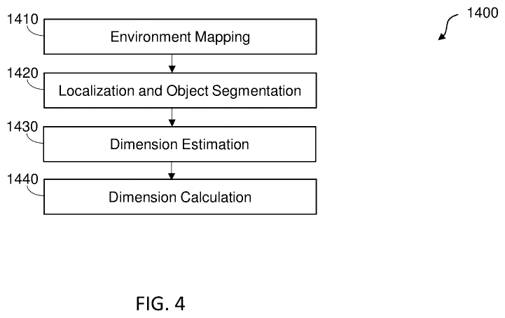

FIG. 4 is a flow diagram of a method 1400 for depth estimation, in accordance with some embodiments. Here, a visual simultaneous localization and mapping (VSLAM) system, for example, illustrated in FIG. 2, is implemented for dimension measurements.

At step 1410, the camera 1203 and optional sensors of the mobile device 1202 are used to perform a visual SLAM operation. The device maps the environment and identifies a ground plane for reference.

At step 1420, the mobile device is localized within the mapped environment. A neural network is used for object segmentation to isolate the object of interest within the camera view.

At step 1430, a dimension estimation process is performed. Here, an interaction with the object by moving the mobile device around it. The device's position and orientation are continuously updated using visual SLAM. Multiple perspectives of the object are captured to gather necessary data.

At step 1440, based on the captured data and spatial awareness from visual SLAM, the dimensions of the object are calculated.

In some applications, when dimensioning an item requires the user to print and attach a label, the system will include capabilities to detect this behavior and seamlessly integrate label scanning and verification processes using various sensor embodiments. Upon initiating the dimensioning process, the system prompts the user to print and attach a label to the object. The system's sensors, including cameras or other suitable technologies, detect the presence of the label on the object. If a barcode is present on the label, the system automatically scans the barcode using integrated scanning capabilities. The system can also utilize OCR technology to read and verify the information on the label, confirming its accuracy and relevance to the dimensioning process. The system can also provide real-time feedback to the user regarding the successful scanning and verification of the label, ensuring proper documentation and labeling of the object during the dimensioning process.

Upon completion of dimensioning, the system may initiate item tracking to monitor the object's transition from the dimensioning area to a staging area. It will utilize real-time tracking data to monitor and record the object's location as it moves through designated areas. The tracking can be performed as mentioned here (a link to our previous tracking patents) or can be as simple as another tracking algorithm following the object from the dimensioning area to the staging area. Automatically assign or update the object's status and location within the tracking system as it reaches the designated staging area (e.g., shelf, bin).

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure, or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, inner, and outer, interior, and exterior, and vertical and horizontal are intended for convenience of description, not to limit the described systems and methods or their components to any one positional or spatial orientation. Accordingly, the foregoing description and drawings are by way of example only, and the scope of the invention should be determined from proper construction of the appended claims, and their equivalents.

What is claimed is:

1. A method for dimensioning objects, comprising:
capturing, by an optical sensor of each of one or more mobile devices, one or more images of an area containing an object;
estimating the three-dimensional representation of the captured images using depth estimation techniques;
identifying the object within the captured images; and
calculating dimensions of the object based on the three-dimensional representation.

2. The method of claim 1, further comprising segmenting the object within at least one image of the one or more images, which is automatically executed when the object is a sole item in a field of view of the optical sensor.

3. The method of claim 1, wherein estimating the three-dimensional representation of one or more images is performed by using a neural network.

4. The method of claim 1, wherein estimating the three-dimensional representation of the one or more images is performed via moving the device around the object, capturing images from different perspectives and utilizing simultaneous localization and mapping techniques.

5. The method of claim 1, wherein the mobile device has a depth sensor, wherein estimating the three-dimensional representation of the one or more images is obtained directly from the depth sensor and the sensor intrinsic properties.

6. The method of claim 5, where the depth sensor is a stereoscopic depth sensor.

7. The method of claim 5, where the depth sensor is a LIDAR.

8. The method of claim 1, wherein the mobile device employs a multi object detection method on the captured images to separate the various objects in the captured images.

9. The method of claim 8, where the multi object detection method is a neural network.

10. The method of claim 1, wherein segmenting the object is automatically executed when the object is the sole item in a field of view of the optical sensor.

11. The method of claim 1, further comprising tracking the movement of the object from a dimensioning area to a staging area using a separate tracking system to create a chain of custody.

12. The method of claim 1, wherein segmenting the object is executed per the user input on the touchscreen by tapping the object in the images.

13. The method of claim 1, where the mobile device is a wearable device.

14. The method of claim 1, where the mobile device is an augmented reality device.

15. The method of claim 14, where in the augmented reality device projects the dimensions of the object around the object when viewed through the device.

16. The method of claim 1, wherein the optical sensor is a camera and/or depth sensor.

17. A method for verifying labels during object dimensioning using a mobile device, comprising:
detecting an attachment of a label to the object during a dimensioning process;
scanning the label using integrated scanning capabilities of the mobile device; and
using the information obtained through the scanning to confirm accuracy and relevance to the dimensioning process.

18. The method of claim 17, wherein the mobile device scans the barcode on the label using one or more optical sensors.

19. The method of claim 17, wherein the mobile device scans a barcode on the label using a laser based barcode scanner.

20. The method of claim 17, wherein the mobile device captures the image of the label placed on the object, and performs an Optical Character Recognition (OCR) operation to obtain the information.

21. The method of claim 17, wherein the mobile device uses NFC to scan the label.

22. The method of claim 17, wherein the mobile device scans an RFID tag on the object.

23. The method of claim 17, further comprising tracking the movement of the object from a dimensioning area to a staging area using a separate tracking system to create a chain of custody.
